(19) United States
(12) Patent Application Publication
(10) Pub. No.: US 2023/0401329 A1
(43) Pub. Date: Dec. 14, 2023

(54) SHARING OF UNSTRUCTURED DATA IN STAGES

(71) Applicant: Snowflake Inc., Bozeman, MT (US)

(72) Inventors: Subramanian Muralidhar, Mercer Island, WA (US); Polita Paulus, Kirkland, WA (US); Saurin Shah, Kirkland, WA (US); Srinidhi Karthik Bisthavalli Srinivasa, Seattle, WA (US)

(21) Appl. No.: 17/933,761

(22) Filed: Sep. 20, 2022

Related U.S. Application Data
(60) Provisional application No. 63/366,302, filed on Jun. 13, 2022.

(51) Int. Cl. G06F 21/62; G06F 16/21

(52) U.S. Cl. CPC G06F 21/6218; G06F 16/211

(57) ABSTRACT

Provided herein are systems and methods for sharing unstructured data in stages. For example, a method includes generating a share object at an account of a data provider. The share object identifies an account of a data consumer and at least one unstructured data file shared with the account of the data consumer. The share object is configured with access privileges to the at least one unstructured data file. A notification of the share object is communicated to the account of the data consumer.

### PRIORITY CLAIM

This application claims the benefit of priority to U.S. Provisional Patent Application 63/366,302, filed Jun. 13, 2022, and entitled “SHARING OF UNSTRUCTURED DATA IN STAGES,” which application is incorporated herein by reference in its entirety.

### TECHNICAL FIELD

Embodiments of the disclosure relate generally to databases and, more specifically, to sharing of unstructured data stored in storage locations such as stages (e.g., internal or external stages).

### BACKGROUND

Databases are widely used for data storage and access in computing applications. A goal of database storage is to provide enormous sums of information in an organized manner so that it can be accessed, managed, updated, and shared. In a database, data may be organized into rows, columns, and tables. Different database storage systems may be used for storing different types of content, such as bibliographic, full text, numeric, and/or image content. Further, in computing, different database systems may be classified according to the organizational approach of the database. There are many different types of databases, including relational databases, distributed databases, cloud databases, object-oriented and others. Secure storage and access of database data may be provided by encrypting and/or storing data in an encrypted form to prevent unauthorized access. In some cases, data sharing may be desirable to let other parties perform queries against a set of data.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a network-based database system in communication with a cloud storage platform, in accordance with some embodiments of the present disclosure.

FIG. 2 is a block diagram illustrating the components of a compute service manager using a data-sharing manager, in accordance with some embodiments of the present disclosure.

FIG. 3 is a block diagram illustrating components of an execution platform, in accordance with some embodiments of the present disclosure.

FIG. 4 illustrates an example regional-deployment map for the example network-based database system of FIG. 1, in accordance with some embodiments of the present disclosure.

FIG. 5 is a computing environment conceptually illustrating an example software architecture executing a user-defined function (UDF) by a process running on a given execution node of the execution platform of FIG. 1, in accordance with some embodiments of the present disclosure.

FIG. 6 illustrates an example computing environment with unstructured data sharing based on data configuration functions performed by a UDF, in accordance with some embodiments of the present disclosure.

FIG. 7 is a block diagram illustrating sharing of unstructured data from a primary deployment account of a data provider to a primary or a remote deployment account of a data consumer using a share object, in accordance with some embodiments of the present disclosure.

FIG. 8 illustrates an example communication flow diagram for sharing unstructured data from an account of a data provider to an account of a data consumer using a share object, in accordance with some embodiments of the present disclosure.

FIG. 9 is a flow diagram illustrating the operations of a database system in performing a method for sharing unstructured data, in accordance with some embodiments of the present disclosure.

FIG. 10 illustrates a diagrammatic representation of a machine in the form of a computer system within which a set of instructions may be executed for causing the machine to perform any one or more of the methodologies discussed herein, in accordance with some embodiments of the present disclosure.

### DETAILED DESCRIPTION

Reference will now be made in detail to specific example embodiments for carrying out the inventive subject matter. Examples of these specific embodiments are illustrated in the accompanying drawings, and specific details are outlined in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

In the present disclosure, physical units of data that are stored in a data platform—and that make up the content of, e.g., database tables in customer accounts—are referred to as micro-partitions. In different implementations, a data platform may store metadata in micro-partitions as well. The term “micro-partitions” is distinguished in this disclosure from the term “files,” which, as used herein, refers to data units such as image files (e.g., Joint Photographic Experts Group (JPEG) files, Portable Network Graphics (PNG) files, etc.), video files (e.g., Moving Picture Experts Group (MPEG) files, MPEG-4 (MP4) files, Advanced Video Coding High Definition (AVCHD) files, etc.), Portable Document Format (PDF) files, documents that are formatted to be compatible with one or more word-processing applications, documents that are formatted to be compatible with one or more spreadsheet applications, and/or the like. If stored internal to the data platform, a given file is referred to herein as an “internal file” and may be stored in (or at, or on, etc.) what is referred to herein as an “internal storage location.” If stored external to the data platform, a given file is referred to herein as an “external file” and is referred to as being stored in (or at, or on, etc.) what is referred to herein as an “external storage location.” These terms are further discussed below.

Computer-readable files come in several varieties, including unstructured files, semi-structured files, and structured files. These terms may mean different things to different people. As used herein, examples of unstructured files include image files, video files, PDFs, audio files, and the like; examples of semi-structured files include JavaScript Object Notation (JSON) files, eXtensible Markup Language (XML) files, and the like; and examples of structured files include Variant Call Format (VCF) files, Keithley Data File (KDF) files, Hierarchical Data Format version 5 (HDF5) files, and the like. As known to those of skill in the relevant arts, VCF files are often used in the bioinformatics field for storing, e.g., gene-sequence variations, KDF files are often used in the semiconductor industry for storing, e.g., semiconductor-testing data, and HDF5 files are often used in industries such as the aeronautics industry, in that case for storing data such as aircraft-emissions data. Numerous other examples of unstructured-file types, semi-structured-file types, and structured-file types, as well as example uses thereof, could certainly be listed here as well and will be familiar to those of skill in the relevant arts. Different people of skill in the relevant arts may classify types of files differently among these categories and may use one or more different categories instead of or in addition to one or more of these.

As used herein, the term “table” indicates a mutable bag of rows, supporting time travel up to a retention period. As used herein, the term “view” indicates a named SELECT statement, conceptually similar to a table. In some aspects, a view can be secure, which prevents queries from getting information on the underlying data obliquely. As used herein, the terms “structured data” and “semi-structured” data refer to, e.g., data stored in tables. As used herein, the term “unstructured data” refers to, e.g., files (also referred to as data files) stored in stages.

Aspects of the present disclosure provide techniques for configuring sharing of unstructured data stored in stages (e.g., internal or external stages, as defined herein below). In some aspects, network-based database systems include configurations and functionalities for data sharing of structured and semi-structured data that is stored in tables. However, existing techniques lack functionalities associated with sharing of unstructured data (e.g., data files) stored in stages (e.g., internal or external storage locations as described herein below).

The unstructured data can be shared using a secure view, but it is not an optimal customer experience. More specifically, the unstructured data uniform resource locators (URLs) are exposed in the view, which can be shared from a provider account to a consumer account. The consumer can then download the files using the URLs. However, this technique is not optimal for several reasons: (a) the provider has to create a secure view for sharing as direct sharing of stages may not be used with conventional storage techniques; (b) the consumer has no access to the stage and, therefore, the consumer cannot perform operations like LIST and GET; and (c) the consumer cannot perform bulk operations on files in the stage as the consumer is restricted to serial operations by processing the URLs one by one.

The disclosed techniques enable sharing of unstructured data by enabling sharing of stages from a provider account to a consumer account. In some aspects, the consumer account can be configured with read-only access to the shared stage. In this regard, the consumer can perform functionalities on the unstructured data in the stage as if the stage exists in the consumer account. Direct sharing of unstructured data further enables the following use cases: (a) the consumer account can be used for performing a LIST operation against the shared stage; (b) the consumer account can be used for performing a GET operation and obtaining data files from the shared stage; (c) the consumer account can be used for performing a bulk copy from the shared stage to another stage in their account; and (d) a cross-cloud data sharing scenario can be configured where the unstructured data (e.g., files) are stored in a stage associated with a first type of cloud storage (e.g., GOOGLE CLOUD PLATFORM™ storage) of a data provider, and the customer account (e.g., a data consumer) uses a second type of cloud storage (e.g., MICROSOFT® AZURE® or AMAZON WEB SERVICES™ (AWS™) cloud storage).

In some aspects, internal stages can be configured to use two privileges (READ privileges and WRITE privileges) which an admin can give to a user account in the network-based database system 102. The WRITE privileges also include DELETE privileges.

In some aspects, external stages are historically configured with USAGE privileges, without separate READ or WRITE privileges. The privileges to the external stage can be based on the privileges of the access credentials used for accessing the stage (e.g., READ or WRITE privileges can be granted only if the credentials have READ or WRITE privileges respectively). However, when tables are shared (e.g., from a provider to a consumer account), the share is read-only. In this regard, the consumer can never change the state of the table on the provider side. The disclosed techniques are used to configure similar semantics if a provider wants to share a stage with the consumer (namely, the stage should always be read-only for the consumer). For an internal stage, read-only access can be achieved by granting only READ privileges on the internal stage to the consumer. For an external stage, Usage privilege is available, which includes both READ and WRITE privileges (if allowed by the access/key credentials). The disclosed techniques introduce separate READ and WRITE privileges for external stages.

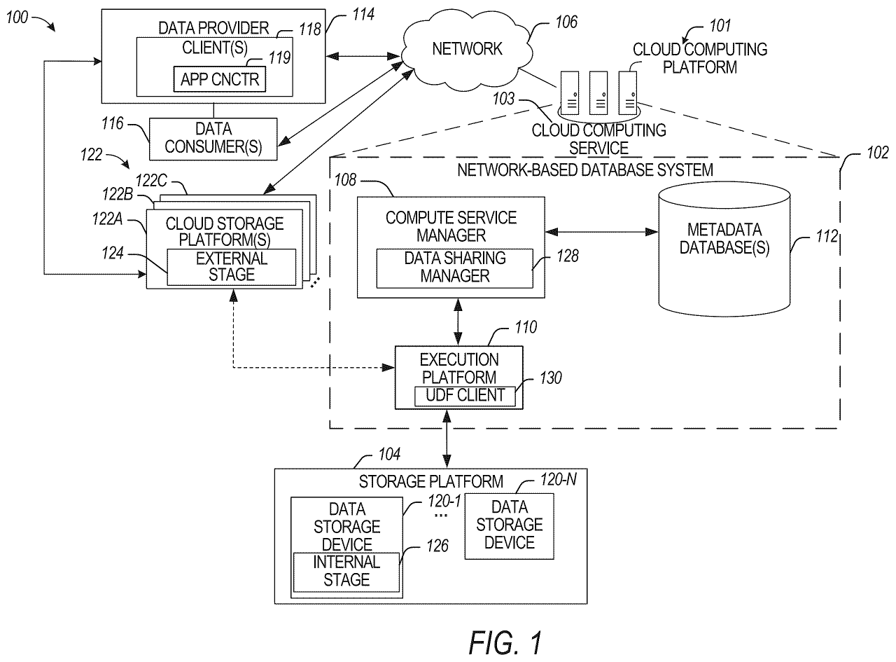

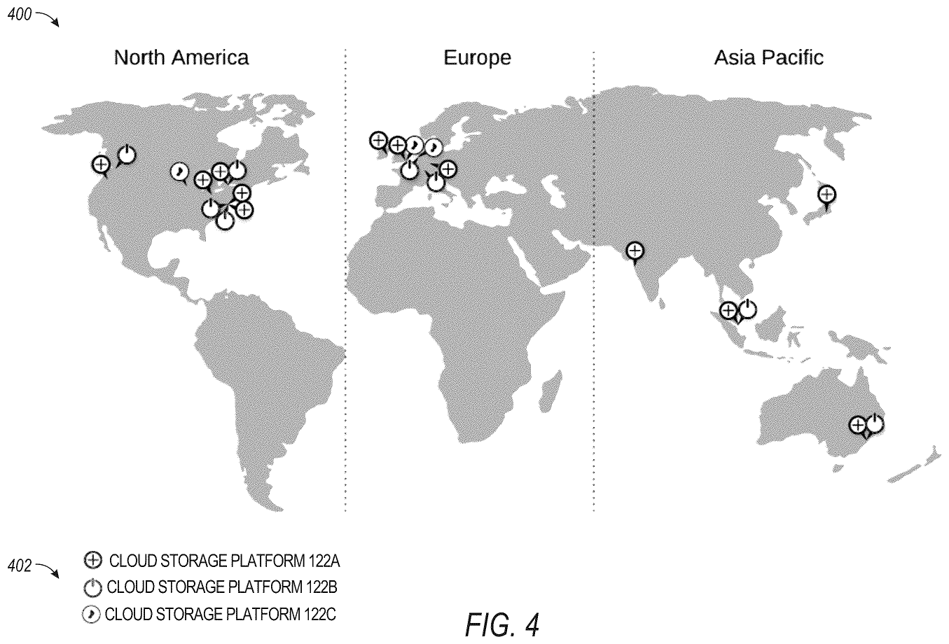

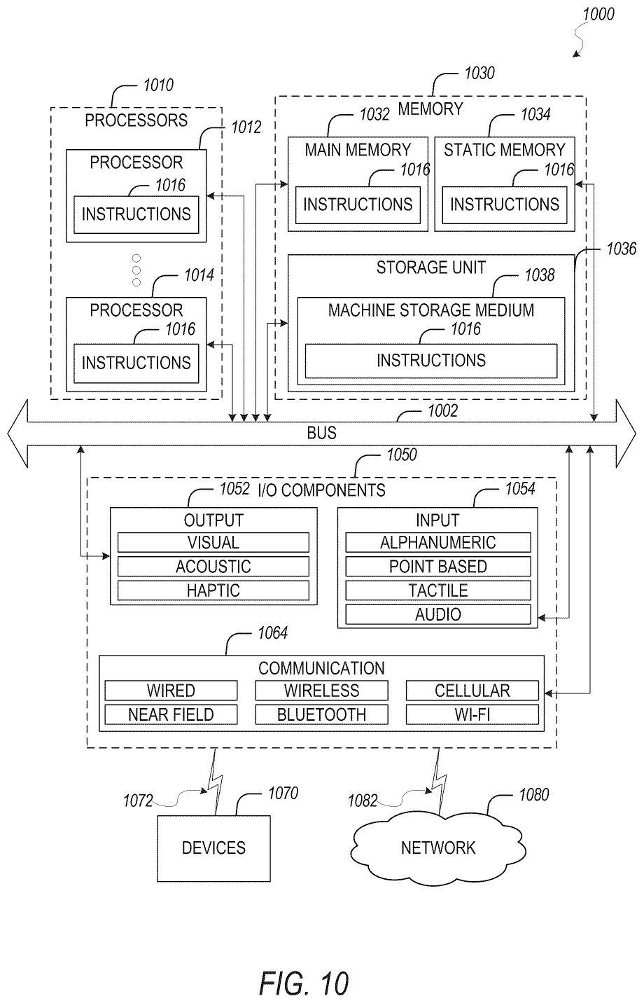

The various embodiments that are described herein are described with reference where appropriate to one or more of the various figures. An example computing environment using a data-sharing manager for configuring sharing of unstructured data in stages is discussed in connection with FIGS. 1-3. Example configuration and functions associated with the data sharing manager and sharing of unstructured data are discussed in connection with FIGS. 4-9. A more detailed discussion of example computing devices that may be used in connection with the disclosed techniques is provided in connection with FIG. 10.

FIG. 1 illustrates an example computing environment 100 that includes a database system in the example form of a network-based database system 102, in accordance with some embodiments of the present disclosure. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein. In other embodiments, the computing environment may comprise another type of network-based database system or a cloud data platform. For example, in some aspects, the computing environment 100 may include a cloud computing platform 101 with the network-based database system 102, storage platforms 104, and cloud storage platforms 122 (which can include cloud storage platforms 122A, 122B, . . . , 122C). The cloud computing platform 101 provides computing resources and storage resources that may be acquired (purchased) or leased (e.g., by data providers and data consumers), and configured to execute applications and store data.

The cloud computing platform 101 may host a cloud computing service 103 that facilitates storage of data on the cloud computing platform 101 (e.g., data management and access) and analysis functions (e.g., SQL queries, analysis), as well as other processing capabilities (e.g., performing the MT-related functions described herein). The cloud computing platform 101 may include a three-tier architecture: data storage (e.g., storage platforms 104 and 122), an execution platform 110, and a compute service manager 108 providing cloud services (e.g., services associated with sharing of unstructured data stored in stages as configured and executed by the data sharing manager 128).

It is often the case that organizations that are customers of a given data platform also maintain data storage (e.g., a data lake) that is external to the data platform (i.e., one or more external storage locations). For example, a company could be a customer of a particular data platform and also separately maintain storage of any number of files—be they unstructured files, semi-structured files, structured files, and/or files of one or more other types—on, as examples, one or more of their servers and/or on one or more cloud-storage platforms such as AMAZON WEB SERVICES™ (AWS™), MICROSOFT® AZURE®, GOOGLE CLOUD PLATFORM™, and/or the like. The customer's servers and cloud-storage platforms are both examples of what a given customer could use as what is referred to herein as an external storage location. The cloud computing platform 101 could also use a cloud-storage platform as what is referred to herein as an internal storage location concerning the data platform.

From the perspective of the network-based database system 102 of the cloud computing platform 101, one or more files (e.g., unstructured data files) that are stored at one or more storage locations are referred to herein as being organized into one or more of what is referred to herein as either “internal stages” or “external stages.” Internal stages are stages that correspond to data storage at one or more internal storage locations, and where external stages are stages that correspond to data storage at one or more external storage locations. In this regard, external files can be stored in external stages at one or more external storage locations, and internal files can be stored in internal stages at one or more internal storage locations, which can include servers managed and controlled by the same organization (e.g., company) that manages and controls the data platform, and which can instead or in addition include data-storage resources operated by a storage provider (e.g., a cloud-storage platform) that is used by the data platform for its “internal” storage. The internal storage of a data platform is also referred to herein as the “storage platform” of the network-based database system. It is further noted that a given external file that given customer stores at a given external storage location may or may not be stored in an external stage in the external storage location—i.e., in some data-platform implementations, it is a customer's choice whether to create one or more external stages (e.g., one or more external-stage objects) in the customer's data-platform account as an organizational and functional construct for conveniently interacting via the data platform with one or more external files. Additionally, data stored in internal stages (e.g., internal stage 126) can be managed by the network-based database system, and data stored in external stages (e.g., external stage 124) can be managed by an account of a data provider (e.g., data provider 114).

As shown, the network-based database system 102 of the cloud computing platform 101 is in communication with the cloud storage platforms 104 and 122 (e.g., AWS®, Microsoft Azure Blob Storage®, or Google Cloud Storage), client devices (or clients) 118 of a data provider 114, and clients of a data consumer 116 via network 106. The network-based database system 102 is a network-based system used for reporting and analysis of integrated data from one or more disparate sources including one or more storage locations within the storage platform 104. The storage platform 104 comprises a plurality of computing machines and provides on-demand computer system resources such as data storage and computing power to the network-based database system 102.

The network-based database system 102 comprises a compute service manager 108, an execution platform 110, and one or more metadata databases 112. The network-based database system 102 hosts and provides data reporting and analysis services (as well as additional services such as the disclosed unstructured data sharing functions) to multiple client accounts, including an account of the data provider 114 associated with client devices 118 (also referred to as a client device 118) and an account of the data consumer 116. In some embodiments, the compute service manager 108 comprises the data sharing manager 128 which can be used in connection with unstructured data sharing functions discussed herein. A more detailed description of the functions provided by the data sharing manager 128 is provided in connection with FIGS. 4-9.

The compute service manager 108 coordinates and manages operations of the network-based database system 102. The compute service manager 108 also performs query optimization and compilation as well as managing clusters of computing services that provide compute resources (also referred to as “virtual warehouses”). The compute service manager 108 can support any number of client accounts such as end-users providing data storage and retrieval requests, accounts of data providers, accounts of data consumers, system administrators managing the systems and methods described herein, and other components/devices that interact with the compute service manager 108.

The compute service manager 108 is also in communication with a client device 118. The client device 118 corresponds to a user of one of the multiple client accounts (e.g., a data provider 114) supported by the network-based database system 102. The data provider may utilize application connector 119 at the client device 118 to submit data storage, retrieval, and analysis requests to the compute service manager 108 as well as to access or configure other services provided by the compute service manager 108 (e.g., services associated with the disclosed unstructured data sharing functions).

Client device 118 (also referred to as user device 118) may include one or more of a laptop computer, a desktop computer, a mobile phone (e.g., a smartphone), a tablet computer, a cloud-hosted computer, cloud-hosted serverless processes, or other computing processes or devices may be used to access services provided by the cloud computing platform 101 (e.g., cloud computing service 103) by way of a network 106, such as the Internet or a private network.

In the description below, actions are ascribed to users, particularly consumers and providers. Such actions shall be understood to be performed concerning client device (or devices) 118 operated by such users. For example, a notification to a user may be understood to be a notification transmitted to client device 118, input or instruction from a user may be understood to be received by way of the client device 118, and interaction with an interface by a user shall be understood to be interaction with the interface on the client device 118. In addition, database operations (joining, aggregating, analysis, etc.) ascribed to a user (consumer or provider) shall be understood to include performing such actions by the cloud computing service 103 in response to an instruction from that user.

In some aspects, a data consumer 116 can communicate with the client device 118 to access functions offered by the data provider 114 (e.g., to access unstructured data shared by the data provider 114). Additionally, the data consumer can access functions (e.g., unstructured data sharing functions) offered by the network-based database system 102 via network 106.

The compute service manager 108 is also coupled to one or more metadata databases 112 that store metadata about various functions and aspects associated with the network-based database system 102 and its users. For example, a metadata database 112 may include a summary of data stored in remote data storage systems as well as data available from a local cache. Additionally, a metadata database 112 may include information regarding how data is organized in remote data storage systems (e.g., the cloud storage platform 104) and the local caches. Information stored by a metadata database 112 allows systems and services to determine whether a piece of data needs to be accessed without loading or accessing the actual data from a storage device.

The compute service manager 108 is further coupled to the execution platform 110, which provides multiple computing resources (e.g., execution nodes) that execute, for example, various data storage, data retrieval, and data processing tasks. The execution platform 110 is coupled to storage platform 104 and cloud storage platforms 122. The storage platform 104 comprises multiple data storage devices 120-1 to 120-N. In some embodiments, the data storage devices 120-1 to 120-N are cloud-based storage devices located in one or more geographic locations. For example, the data storage devices 120-1 to 120-N may be part of a public cloud infrastructure or a private cloud infrastructure. The data storage devices 120-1 to 120-N may be hard disk drives (HDDs), solid-state drives (SSDs), storage clusters, Amazon S3™ storage systems, or any other data-storage technology. Additionally, the cloud storage platform 104 may include distributed file systems (such as Hadoop Distributed File Systems (HDFS)), object storage systems, and the like. In some embodiments, at least one internal stage 126 may reside on one or more of the data storage devices 120-1-120-N, and at least one external stage 124 may reside on one or more of the cloud storage platforms 122.

In some embodiments, the execution platform 110 can include a user-defined function (UDF) client 130, which can be used in connection with the unstructured data sharing functions disclosed herein.

In some embodiments, communication links between elements of the computing environment 100 are implemented via one or more data communication networks, such as network 106. These data communication networks may utilize any communication protocol and any type of communication medium. In some embodiments, the data communication networks are a combination of two or more data communication networks (or sub-Networks) coupled with one another. In alternate embodiments, these communication links are implemented using any type of communication medium and any communication protocol.

The compute service manager 108, metadata database 112, execution platform 110, and storage platform 104, are shown in FIG. 1 as individual discrete components. However, each of the compute service manager 108, metadata database 112, execution platform 110, and storage platforms 104 and 122 may be implemented as a distributed system (e.g., distributed across multiple systems/platforms at multiple geographic locations). Additionally, each of the compute service manager 108, metadata database(s) 112, execution platform 110, and storage platforms 104 and 122 can be scaled up or down (independently of one another) depending on changes to the requests received and the changing needs of the network-based database system 102. Thus, in the described embodiments, the network-based database system 102 is dynamic and supports regular changes to meet the current data processing needs.

During typical operation, the network-based database system 102 processes multiple jobs determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more nodes of the execution platform 110 to process the task. The compute service manager 108 may determine what data is needed to process a task and further determine which nodes within the execution platform 110 are best suited to process the task. Some nodes may have already cached the data needed to process the task and, therefore, be a good candidate for processing the task. Metadata stored in a metadata database 112 assists the compute service manager 108 in determining which nodes in the execution platform 110 have already cached at least a portion of the data needed to process the task. One or more nodes in the execution platform 110 process the task using data cached by the nodes and, if necessary, data retrieved from the cloud storage platform 104. It is desirable to retrieve as much data as possible from caches within the execution platform 110 because the retrieval speed is typically much faster than retrieving data from the cloud storage platform 104.

As shown in FIG. 1, the cloud computing platform 101 of the computing environment 100 separates the execution platform 110 from the storage platform 104. In this arrangement, the processing resources and cache resources in the execution platform 110 operate independently of the data storage devices 120-1 to 120-N in the cloud storage platform 104. Thus, the computing resources and cache resources are not restricted to specific data storage devices 120-1 to 120-N. Instead, all computing resources and all cache resources may retrieve data from, and store data to, any of the data storage resources in the cloud storage platform 104.

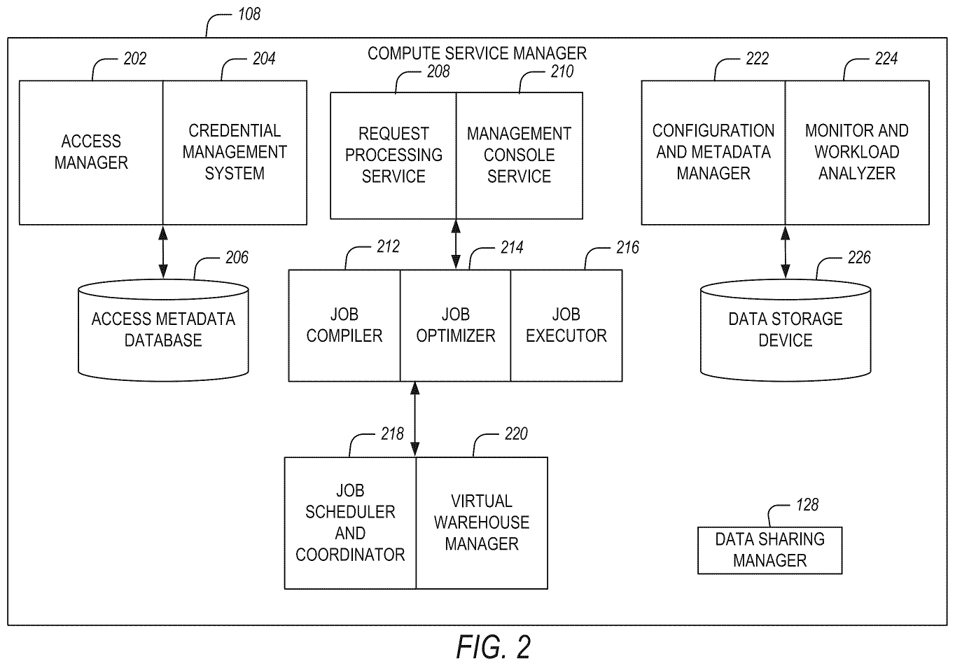

FIG. 2 is a block diagram illustrating components of the compute service manager 108, in accordance with some embodiments of the present disclosure. As shown in FIG. 2, the compute service manager 108 includes an access manager 202 and a credential management system 204 coupled to an access metadata database 206, which is an example of the metadata database(s) 112. Access manager 202 handles authentication and authorization tasks for the systems described herein. The credential management system 204 facilitates the use of remotely stored credentials to access external resources such as data resources in a remote storage device. As used herein, the remote storage devices may also be referred to as “persistent storage devices” or “shared storage devices.” For example, the credential management system 204 may create and maintain remote credential store definitions and credential objects (e.g., in the access metadata database 206). A remote credential store definition identifies a remote credential store and includes access information to access security credentials from the remote credential store. A credential object identifies one or more security credentials using non-sensitive information (e.g., text strings) that are to be retrieved from a remote credential store for use in accessing an external resource. When a request invoking an external resource is received at run time, the credential management system 204 and access manager 202 use information stored in the access metadata database 206 (e.g., a credential object and a credential store definition) to retrieve security credentials used to access the external resource from a remote credential store.

A request processing service 208 manages received data storage requests and data retrieval requests (e.g., jobs to be performed on database data). For example, the request processing service 208 may determine the data to process a received query (e.g., a data storage request or data retrieval request). The data may be stored in a cache within the execution platform 110 or in a data storage device in storage platform 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. Job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs may be prioritized and then processed in that prioritized order. In an embodiment, the job scheduler and coordinator 218 determines a priority for internal jobs that are scheduled by the compute service manager 108 with other “outside” jobs such as user queries that may be scheduled by other systems in the database but may utilize the same processing resources in the execution platform 110. In some embodiments, the job scheduler and coordinator 218 identifies or assigns particular nodes in the execution platform 110 to process particular tasks. A virtual warehouse manager 220 manages the operation of multiple virtual warehouses implemented in the execution platform 110. For example, the virtual warehouse manager 220 may generate query plans for executing received queries.

Additionally, the compute service manager 108 includes configuration and metadata manager 222, which manages the information related to the data stored in the remote data storage devices and the local buffers (e.g., the buffers in the execution platform 110). The configuration and metadata manager 222 uses metadata to determine which data files need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the network-based database system 102 and may further redistribute tasks based on a user (e.g., “external”) query workload that may also be processed by the execution platform 110. The configuration and metadata manager 222 and the monitor and workload analyzer 224 are coupled to a data storage device 226. The data storage device 226 in FIG. 2 represents any data storage device within the network-based database system 102. For example, data storage device 226 may represent buffers in execution platform 110, storage devices in storage platform 104, or any other storage device.

As described in embodiments herein, the compute service manager 108 validates all communication from an execution platform (e.g., the execution platform 110) to validate that the content and context of that communication are consistent with the task(s) known to be assigned to the execution platform. For example, an instance of the execution platform executing query A should not be allowed to request access to data-source D (e.g., data storage device 226) that is not relevant to query A. Similarly, a given execution node (e.g., execution node 302-1 may need to communicate with another execution node (e.g., execution node 302-2), and should be disallowed from communicating with a third execution node (e.g., execution node 312-1) and any such illicit communication can be recorded (e.g., in a log or other location). Also, the information stored on a given execution node is restricted to data relevant to the current query and any other data is unusable, rendered so by destruction or encryption where the key is unavailable.

In some embodiments, the compute service manager 108 further includes the data sharing manager 128 which can be used in connection with unstructured data sharing functions discussed herein.

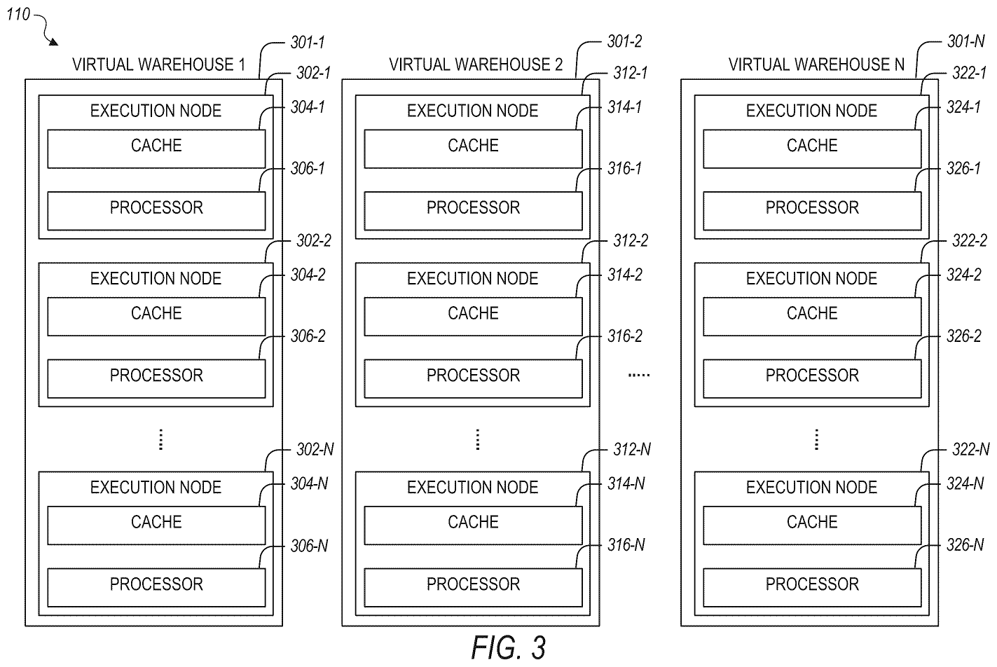

FIG. 3 is a block diagram illustrating components of the execution platform 110, in accordance with some embodiments of the present disclosure. As shown in FIG. 3, the execution platform 110 includes multiple virtual warehouses, including virtual warehouse 1 (or 301-1), virtual warehouse 2 (or 301-2), and virtual warehouse N (or 301-N). Each virtual warehouse includes multiple execution nodes that each include a data cache and a processor. The virtual warehouses can execute multiple tasks in parallel by using multiple execution nodes. As discussed herein, the execution platform 110 can add new virtual warehouses and drop existing virtual warehouses in real-time based on the current processing needs of the systems and users. This flexibility allows the execution platform 110 to quickly deploy large amounts of computing resources when needed without being forced to continue paying for those computing resources when they are no longer needed. All virtual warehouses can access data from any data storage device (e.g., any storage device in the cloud storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary.

Each virtual warehouse is capable of accessing any of the data storage devices 120-1 to 120-N shown in FIG. 1. Thus, the virtual warehouses are not necessarily assigned to a specific data storage device 120-1 to 120-N and, instead, can access data from any of the data storage devices 120-1 to 120-N within the cloud storage platform 104. Similarly, each of the execution nodes shown in FIG. 3 can access data from any of the data storage devices 120-1 to 120-N. In some embodiments, a particular virtual warehouse or a particular execution node may be temporarily assigned to a specific data storage device, but the virtual warehouse or execution node may later access data from any other data storage device.

In the example of FIG. 3, virtual warehouse 1 includes three execution nodes 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some embodiments, the execution nodes shown in FIG. 3 are stateless with respect to the data being cached by the execution nodes. For example, these execution nodes do not store or otherwise maintain state information about the execution node or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each includes one data cache and one processor, alternative embodiments may include execution nodes containing any number of processors and any number of caches. Additionally, the caches may vary in size among the different execution nodes. The caches shown in FIG. 3 store, in the local execution node, data that was retrieved from one or more data storage devices in the cloud storage platform 104. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the cloud storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some embodiments, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor-intensive. Similarly, an execution node may be assigned more cache resources if the tasks performed by the execution node require a larger cache capacity.

Although virtual warehouses 1, 2, and N are associated with the same execution platform 110, virtual warehouses 1, . . . , N may be implemented using multiple computing systems at multiple geographic locations. For example, virtual warehouse 1 can be implemented by a computing system at a first geographic location, while virtual warehouses 2 and n are implemented by another computing system at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location, and execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 110 is also fault-tolerant. For example, if one virtual warehouse fails, that virtual warehouse is quickly replaced with a different virtual warehouse at a different geographic location.

A particular execution platform 110 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some embodiments, the virtual warehouses may operate on the same data in the cloud storage platform 104, but each virtual warehouse has its execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

FIG. 4 illustrates an example regional-deployment map 400 for the example network-based database system of FIG. 1, in accordance with at least one embodiment. The regional-deployment map 400 is presented purely by way of example and not limitation, as different numbers and/or boundaries of regions could be demarcated in different implementations. As can be seen in FIG. 4, the regional-deployment map 400 includes three example regions: North America, Europe, and the Asia Pacific. Moreover, various instances of deployments of the cloud storage platform 122 (which can also include deployments of the network-based database system 102) are depicted on the regional-deployment map 400. A legend 402 shows that deployments having a circle with a “+” sign therein are representative of deployments of the network-based database system 102 that are hosted by the cloud storage platform 122A. Additionally, a power-on symbol is used in FIG. 4 to represent deployments of the network-based database system 102 that are hosted by the cloud storage platform 122B, and circles having a musical note icon therein are shown as being representative of deployments of the network-based database system 102 that are hosted by the cloud storage platform 122C.

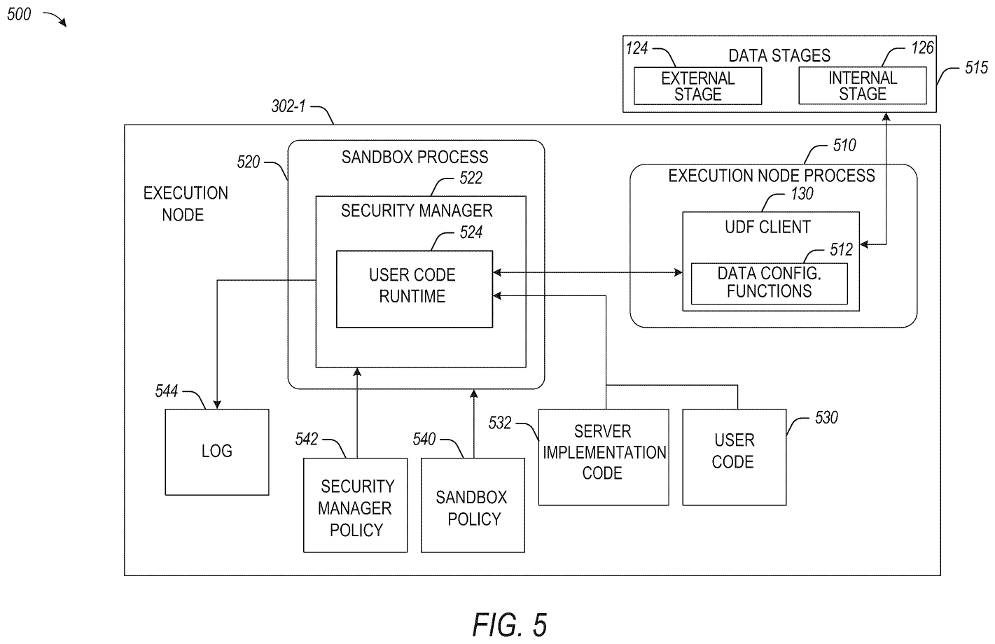

FIG. 5 is a computing environment 500 conceptually illustrating an example software architecture executing a user-defined function (UDF) by a process running on a given execution node of the execution platform 110 of FIG. 1, in accordance with some embodiments of the present disclosure.

In computer security, a sandbox (e.g., sandbox environment) is a security mechanism for separating running programs, usually to mitigate system failures or software vulnerabilities from spreading. A sandbox can be used to execute untested or untrusted programs or code, possibly from unverified or untrusted third parties, suppliers, users, or websites, without risking harm to the host machine or operating system. A sandbox can provide a tightly controlled set of resources for guest programs to run in, such as storage and memory scratch space. Network access, the ability to inspect the host system, or read from input devices can be disallowed or restricted.

As illustrated, the execution node 302-1 from the execution platform 110 includes an execution node process 510, which in an embodiment is running on the processor 306-1 and can also utilize memory from the cache 304-1 (or another memory device or storage). As mentioned herein, a “process” or “computing process” can refer to an instance of a computer program that is being executed by one or more threads by an execution node or execution platform.

As mentioned before, the compute service manager 108 validates all communication from the execution platform 110 to validate that the content and context of that communication are consistent with the task(s) known to be assigned to the execution platform 110. For example, the execution platform 110 executing a query A is not allowed to request access to a particular data source (e.g., data storage device 226 or any one of the storage devices in the cloud storage platform 104) that is not relevant to query A. In an example, the execution node 302-1 may need to communicate with a second execution node (e.g., execution node 302-2), but the security mechanisms described herein can disallow communication with a third execution node (e.g., execution node 312-1). Moreover, any such illicit communication can be recorded (e.g., in a log 544 or another location). Further, the information stored on a given execution node is restricted to data relevant to the current query and any other data is unusable by destruction or encryption where the key is unavailable.

The execution node process 510 is executing a UDF client 130 in the example of FIG. 5. In an embodiment, the UDF client 130 is implemented to support UDFs written in a particular programming language such as JAVA, and the like. In an embodiment, the UDF client 130 is implemented in a different programming language (e.g., Python, C, or C++) than the user code runtime 524, which can further improve the security of the computing environment 500 by using a different codebase (e.g., one without the same or fewer potential security exploits).

User code 530 may be provided as a package e.g., in the form of a JAR (JAVA archive) file which includes code for one or more UDFs. Server implementation code 532, in an embodiment, is a JAR file that initiates a server that is responsible for receiving requests from the execution node process 510, assigning worker threads to execute user code, and returning the results, among other types of server tasks.

In an implementation, an operation from a UDF (e.g., JAVA-based UDF) can be performed by a user code runtime 524 executing within a sandbox process 520 (described further below). In an embodiment, the user code runtime 524 is implemented as a virtual machine, such as a JAVA virtual machine (JVM). Since the user code runtime 524 advantageously executes in a separate process relative to the execution node process 510, there is a lower risk of manipulating the execution node process 510. Results of performing the operation, among other types of information or messages, can be stored in log 544 for review and retrieval. In an embodiment, the log 544 can be stored locally in memory at the execution node 302-1, or in a separate location such as the storage platform 104. Moreover, such results can be returned from the user code runtime 524 to the UDF client 130 utilizing a high-performance protocol (e.g., without serialization or deserialization of data, without memory copies; operates on record batches without having to access individual columns, records or cells; utilizes efficient remote procedure call techniques and network protocol(s) for data transfer) for data transfer (e.g., distributed datasets) that further provides authentication and encryption of the data transfer. In an embodiment, the UDF client 130 uses a data transport mechanism that supports a network transfer of columnar data between the user code runtime 524 (and vice-versa) with the aforementioned advantages described above.

In an example embodiment, the UDF client 130 is configured to perform data configuration functions 512 in connection with the unstructured data sharing techniques discussed herein. More specifically, the data sharing manager 128 communicates with the security manager 522 and triggers the UDF client 130 to perform one or more of the data configuration functions 512 on unstructured data stored in data stages 515 (including internal stage 126 and external stage 124). For example, data configuration functions 512 may include performing data authentication, data reformatting (e.g., from one file type to another), or other data configuration or manipulation (e.g., watermarking, adding password protection, adjusting/granting/revoking access privileges including read and write privileges, etc.) as may be requested by a data provider before sharing unstructured data with a data consumer.

Security manager 522, in an example, can prevent the completion of an operation from a given UDF by throwing an exception (e.g., if the operation is not permitted), or returns (e.g., doing nothing) if the operation is permitted. In an implementation, the security manager 522 is implemented as a JAVA security manager object that allows applications to implement a security policy such as a security manager policy 542 and enables an application to determine, before performing a possibly unsafe or sensitive operation, what the operation is and whether it is being attempted in a security context that allows the operation to be performed. The security manager policy 542 can be implemented as a file with permissions that the user code runtime 524 is granted. The application (e.g., UDF executed by the user code runtime 524) therefore can allow or disallow the operation based at least in part on the security policy.

Sandbox process 520, in an embodiment, is a sub-process (or separate process) from the execution node process 510. A sub-process, in an embodiment, refers to a child process of a given parent process (e.g., in this example, the execution node process 510). The sandbox process 520, in example, is a program that reduces the risk of security breaches by restricting the running environment of untrusted applications using security mechanisms such as namespaces and secure computing modes (e.g., using a system call filter to an executing process and all its descendants, thus reducing the attack surface of the kernel of a given operating system). Moreover, in an example, the sandbox process 520 is lightweight in comparison to the execution node process 510 and is optimized (e.g., closely coupled to security mechanisms of a given operating system kernel) to process a database query securely within the sandbox environment.

In an embodiment, the sandbox process 520 can utilize a virtual network connection to communicate with other components within the subject system. A specific set of rules can be configured for the virtual network connection with respect to other components of the subject system. For example, such rules for the virtual network connection can be configured for a particular UDF to restrict the locations (e.g., particular sites on the Internet or components that the UDF can communicate) that are accessible by operations performed by the UDF. Thus, in this example, the UDF can be denied access to particular network locations or sites on the Internet.

The sandbox process 520 can be understood as providing a constrained computing environment for a process (or processes) within the sandbox, where these constrained processes can be controlled and restricted to limit access to certain computing resources.

Examples of security mechanisms can include the implementation of namespaces in which each respective group of processes executing within the sandbox environment has access to respective computing resources (e.g., process IDs, hostnames, user IDs, file names, names associated with network access, and inter-process communication) that are not accessible to another group of processes (which may have access to a different group of resources not accessible by the former group of processes), other container implementations, and the like. By having the sandbox process 520 execute as a sub-process to the execution node process 510, in some embodiments, latency in processing a given database query can be substantially reduced (e.g., a reduction in latency by a factor of 10× in some instances) in comparison with other techniques that may utilize a virtual machine solution by itself.

As further illustrated, the sandbox process 520 can utilize a sandbox policy 540 to enforce a given security policy. The sandbox policy 540 can be a file with information related to a configuration of the sandbox process 520 and details regarding restrictions if any, and permissions for accessing and utilizing system resources. Example restrictions can include restrictions to network access, or file system access (e.g., remapping the file system to place files in different locations that may not be accessible, other files can be mounted in different locations, and the like). The sandbox process 520 restricts the memory and processor (e.g., CPU) usage of the user code runtime 524, ensuring that other operations on the same execution node can execute without running out of resources.

As mentioned above, the sandbox process 520 is a sub-process (or separate process) from the execution node process 510, which in practice means that the sandbox process 520 resides in separate memory space from the execution node process 510. In an occurrence of a security breach in connection with the sandbox process 520 (e.g., by errant or malicious code from a given UDF), if arbitrary memory is accessed by a malicious actor, the data or information stored by the execution node process is protected.

Although the above discussion of FIG. 4 describes components that are implemented using JAVA (e.g., object-oriented programming language), it is appreciated that the other programming languages (e.g., interpreted programming languages) are supported by the computing environment 500. In an embodiment, PYTHON is supported for implementing and executing UDFs in the computing environment 500. In this example, the user code runtime 524 can be replaced with a PYTHON interpreter for executing operations from UDFs (e.g., written in PYTHON) within the sandbox process 520.

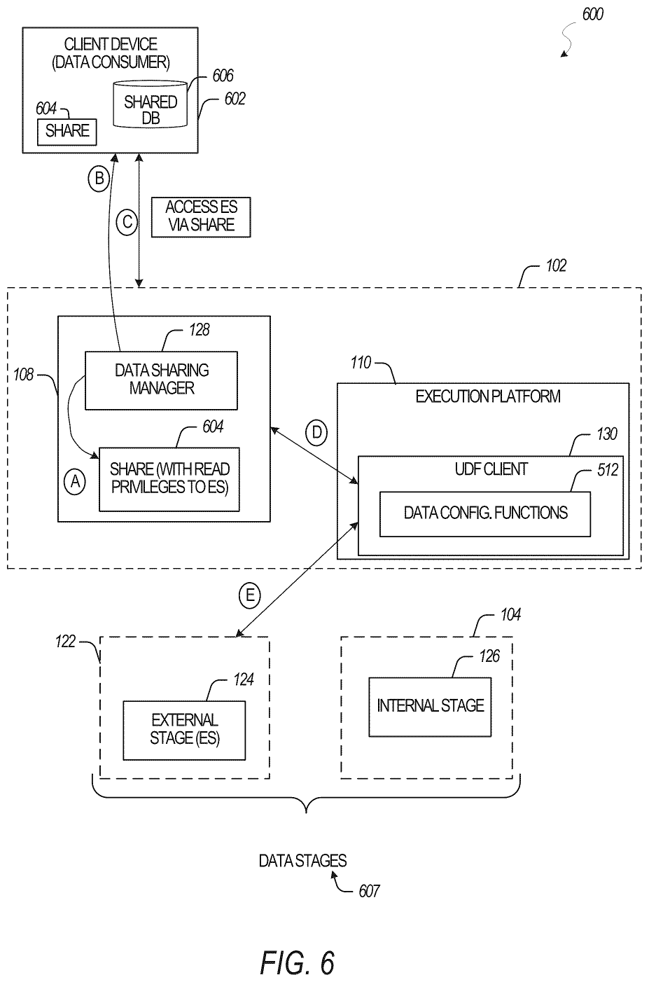

FIG. 6 illustrates an example computing environment 600 with unstructured data sharing based on data configuration functions performed by a UDF, in accordance with some embodiments of the present disclosure. Referring to FIG. 6, the computing environment 600 is similar to the computing environment 100 and includes a client device (or devices) 602 (e.g., associated with a data consumer) in communication with a cloud computing platform with a network-based database system 102 and data stages 607. The network-based database system 102 includes the compute service manager 108 and the execution platform 110. The data stages 607 include storage platform 104 with an internal stage 126 and cloud-storage platform 122 with an external stage 124. The compute service manager 108 is configured with the data sharing manager 128, and the execution platform 110 is configured with the UDF client 130.

The external stage 124 and the internal stage 126 store data (e.g., unstructured data files) associated with a data producer (or data provider).

As discussed herein, in at least some embodiments, a share (or a share object) is an object that encapsulates information that can be used to share a database. In some aspects, a share can include: (a) the privileges that grant access to the database(s) and the schema containing the objects to share; (b) the privileges that grant access to specific objects in the database; and (c) the consumer account(s) with which the database and its objects are shared. Once a database is created (e.g., in a consumer account) from a share, all the shared objects are accessible to users of the consumer account. Shares are secure, configurable, and can be controlled by the provider account. New objects added to a share become immediately available to all consumers (e.g., users of the consumer account), providing real-time access to shared data. Access to a share (or any of the objects in a share) can be revoked at any time.

In this regard, a share is an object that acts as an access-control (including, e.g., visibility control) container for, e.g., a database. In various embodiments, only entities that have had a given share shared with them can see and access whatever one or more objects (e.g., one or more databases) are encompassed by that given share. A given entity, user, and/or the like could also or instead have been assigned privileges to access a given share in a manner that does not necessarily fit the “sharing a share” paradigm that is discussed in the present disclosure by way of example. Other particular rules-based access control (RBAC) approaches could be used as well.

In some aspects, after a share is generated/created (e.g., by an account of a data provider), a read-only version of the share is added to the account(s) of the data consumer indicated by the share. Additionally, a read-only database is created as a version of the shared database configured by the share.

In some aspects, the read-only versions of the share and the database are stored in the account of the data consumer account. Alternatively, the account of the data consumer is provided with metadata or other instance information granting read-only privileges to the shared database which is stored at a storage location controlled by the account of the data provider.

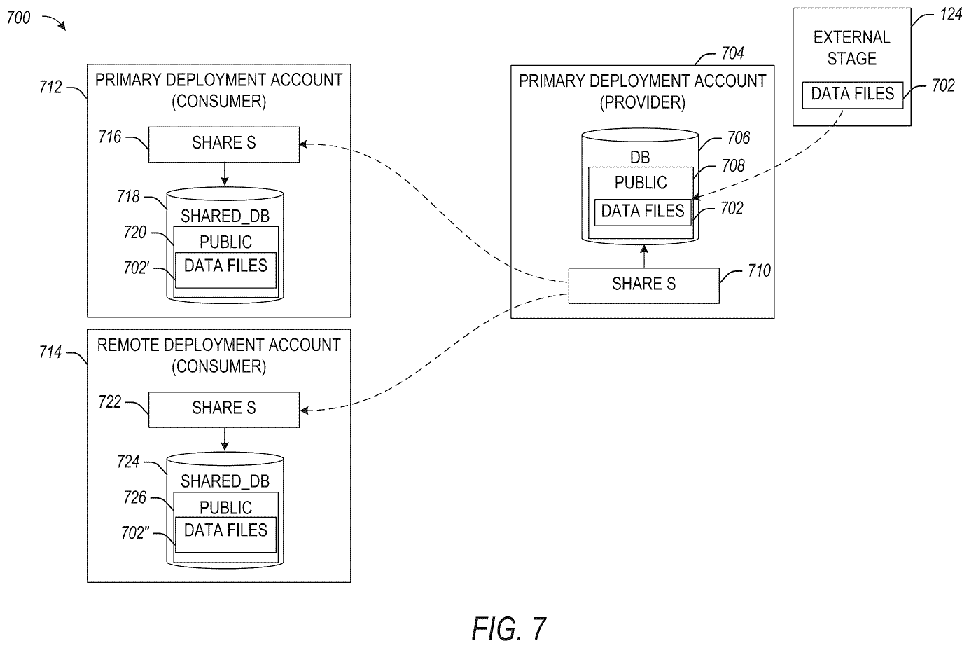

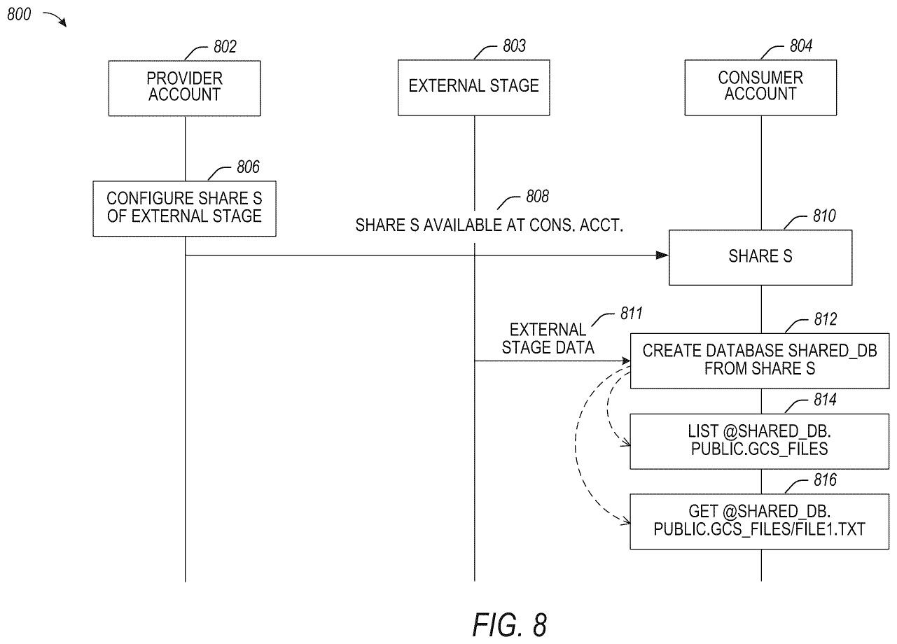

In some aspects, a share can be created on a stage (e.g., an external stage or an internal stage) to configure sharing of unstructured data stored in the stage. For example and referring to FIG. 6, at operation A, the data sharing manager 128 generates a share 604 which is configured with READ privileges to the external stage 124. The share 604 can further specify an account of the data consumer (e.g., the data consumer associated with client device 602). After the share 604 is created, at operation B, it is shared with and appears at the account of the data consumer (e.g., a copy can be stored at the client device 602 and/or a notification of the shared share 604 is generated and communicated to the client device 602). The generation of share 604 can also cause the generation of a read-only database (or a shared database 606) at the client device 602. The shared database 606 includes one or more data objects shared by the account of the data provider and indicated by share 604. For example, the shared database 606 can include unstructured data files from the external stage 124. Additionally, share 604 grants READ privileges so that the account of the data consumer can access the unstructured data files in the external stage 124 (e.g., during operations C, D, and E, as illustrated in FIG. 6 and as described in connection with FIG. 7 and FIG. 8).

In some embodiments, the UDF client 130 can perform one or more data configuration functions 512 on unstructured data retrieved from the external stage 124 before it is shared with the account of the data consumer. In some aspects, the UDF client 130 uses a UDF to cause the data configuration functions 512 to perform network transfer of unstructured data files from one or both of the external stage 124 and the internal stage 126. In some aspects, one or more of the data configuration functions 512 can be configured (e.g., indicated) by the share 604 or by a separate UDF used by the UDF client 130.

FIG. 7 is a block diagram illustrating sharing of unstructured data from a primary deployment account of a data provider to a primary or a remote deployment account of a data consumer using a share object, in accordance with some embodiments of the present disclosure. Referring to FIG. 7, the illustrated example multi-deployment arrangement 700 includes a primary deployment account 704 (which can be an account of the data provider 114 associated with a primary deployment of the network-based database system 102), a primary deployment account 712 (which can be an account of the data consumer 116 associated with the primary deployment of the network-based database system 102), and a remote deployment account 714 (which can be another account of the data consumer associated with a remote deployment of the network-based database system 102).

The data provider 114 manages an external stage 124 which includes unstructured data such as data files 702. In some aspects, data files 702 can include Google Cloud Storage® (GCS) files or other types of data files. Also resident in the primary deployment account 704 is a primary deployment share S 710, which in various embodiments is a companion object to the external stage 124. As discussed herein, in at least some embodiments, a share is a data object that acts as an access-control (including, e.g., visibility control) container for, e.g., a database or a stage. In some aspects, share S 710 can be configured (e.g., by the data sharing manager 128) using the following commands listed in Table 1:

TABLE 1

Use database db;
Use schema public;
Create stage gcs_files url = ′gcs://....′
storage_integration = ...
Grant Read on gcs_files to share s;

In the example of Table 1, database DB 706 is created with schema PUBLIC 708 to host data files 702 of the external stage 124. Additionally, READ privileges are configured for the share S 710. The READ privileges can be applied to an account the share S 710 is shared with. In some aspects, share S 710 is shared with at least one account of the data consumer 116, such as the primary deployment account 712 and the remote deployment account 714.

When share S 710 is created, corresponding notifications can be communicated to accounts 712 and 714, and corresponding read-only versions of the share (e.g., shares 716 and 722) can be configured in the corresponding accounts 712 and 714. Shares 716 and 722 can cause the generation of corresponding shared databases SHARED_DB 718 and 724 in the corresponding accounts 712 and 714 of the data consumer. Shared databases SHARED_DB 718 and 724 are generated and configured with corresponding schemas PUBLIC 720 and 726, which correspond (e.g., can be the same as) schema PUBLIC 708 in the primary deployment account 704. Additionally, since share S 710 further configures READ privileges for data files 702 in the external stage 124, corresponding read-only data file versions 702′ and 702″ of data files 702 can be stored in the corresponding schemas PUBLIC 720 and 726.

In some aspects, shared databases SHARED_DB 718 and 724 can be configured at the corresponding accounts 712 and 714 (e.g., by the data sharing manager 128) using the following command: “Create database shared_db from share s.” After shared databases SHARED_DB 718 and 724 are created, accounts 712 and 714 can access the data files 702 based on the configured READ privileges to execute data manipulation commands, including LIST (to list all data files in one of the shared databases SHARED_DB 718 and 724) and GET (to download a data file available in one of the shared databases SHARED_DB 718 and 724). For example, the following commands listed in Table 2 can be executed at accounts 712 and 714 of the data consumer:

TABLE 2

List @shared_db.public.gcs_files;
Get @shared_db.public.gcs_files/file1.txt;

In some aspects, the following commands listed in Table 3 can be used (e.g., by the data sharing manager 128) to configure one or more of the following additional privileges (e.g., for a data access role or a share) or revoke previously granted privileges:

TABLE 3

grant READ on stage db.schema.ext_stage to role sales_r;
grant READ on stage db.schema.ext_stage to share sales_s;
grant WRITE on stage db.schema.ext_stage to role sales_r;
revoke READ on stage db.schema.ext_stage from role sales_r;
revoke WRITE on stage db.schema.ext_stage from role sales_r;

In some aspects, WRITE privileges for an external stage may not be granted and the following command will fail: “grant WRITE on stage db.schema.ext_stage to share sales_s.”

In some aspects, the data sharing manager 128 can split a USAGE privilege into READ and WRITE privileges so that both privileges can be applied/configured separately in privileges associated with access to external stage data. In this regard, if a USAGE privilege is detected by the data sharing manager 128, it can be translated to READ and WRITE privileges during parsing/compilation. In some aspects, the USAGE privilege can be revoked. In some embodiments, READ and WRITE privileges can be granted and revoked in connection with external stage access. In some aspects, a “SHOW GRANTS” command can show READ and WRITE instead of USAGE.

In some aspects, the following commands and change effects listed in Table 4 are configured by the data sharing manager 128 in connection with sharing unstructured data stored in stages:

TABLE 4

| COMMAND (IN THE | |
|---|---|
| EXTERNAL STAGE) | CHANGE EFFECT |
| grant USAGE | Will not work |
| revoke USAGE | Will not work |
| grant READ/(READ, WRITE) | grant READ/(READ, WRITE) |
| revoke READ/(READ, WRITE) | revoke READ/(READ, WRITE) |
| future grant/revoke USAGE | grant/revoke USAGE, READ, |
| | WRITE |
| future grant/revoke READ/(READ, | grant/revoke READ/(READ, |
| WRITE) | WRITE) |
| grant/revoke READ on stage | grant/revoke READ on stage |
| to SHARE | to SHARE |

FIG. 8 illustrates an example communication flow diagram 800 for sharing unstructured data from an account of a data provider to an account of a data consumer using a share object, in accordance with some embodiments of the present disclosure.

In some aspects, the data sharing manager 128 creates READ privileges on an external stage (e.g., in connection with sharing the stage with a consumer account as initiated by a provider account). Even if the external stage 803 is created with super credentials (e.g., credentials allowing for both READ and WRITE privileges), the disclosed techniques are used to configure sharing of unstructured data in the external stage only with READ privileges.

Referring to FIG. 8, the illustrated communication flow diagram 800 can be based on the description of FIG. 7. More specifically, the illustrated communication flow includes provider account 802 (which can be the same as account 704 of data provider 114), a consumer account 804 (which can be the same as account 712 or 714 of data consumer 116), and external stage 803 (which can be the same as external stage 124).

At operation 806, the data sharing manager 128 can configure a share S of external stage 803. The configuration of share S can be similar to the configuration of share S 710 of FIG. 7. At operation 808, share S becomes available as share S 810 at the consumer account 804. At operation 812, a database SHARED_DB with schema PUBLIC is created from share S 810. Additionally, at operation 811, schema PUBLIC in database SHARED_DB is populated with unstructured data from the external stage 803. As the unstructured data can now be accessed at the consumer account 804 using the populated SHARED_DB database, the consumer account 804 can execute various commands on the unstructured data based on the privileges (e.g., READ privileges) granted by the share S 810. Such example commands include the LIST command 814 (e.g., to obtain a list of unstructured data files available in the external stage 803) and a GET command 816 (e.g., to obtain a specific data file available at the external stage 803).

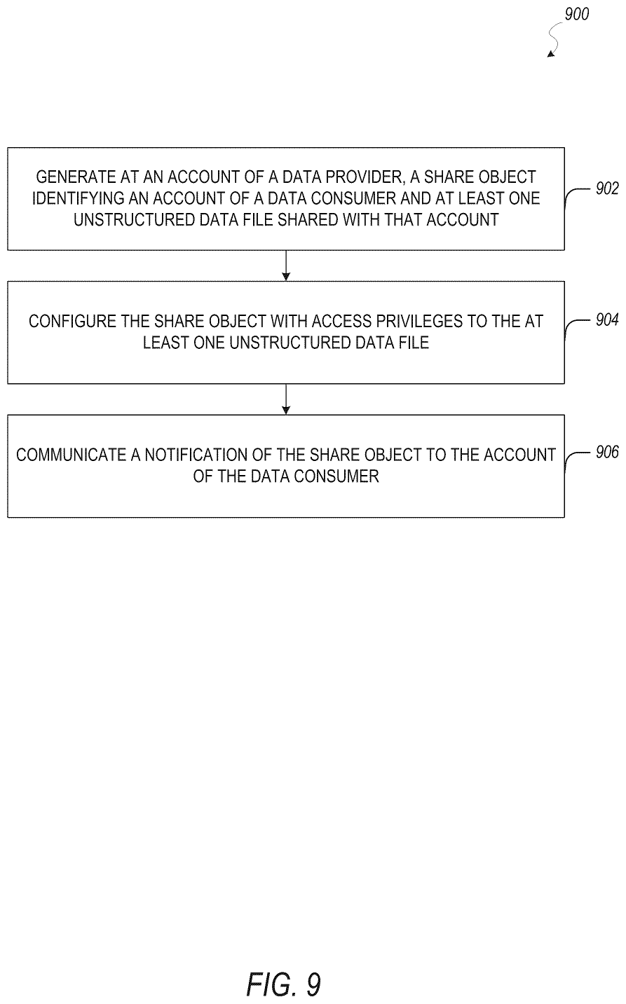

FIG. 9 is a flow diagram illustrating the operations of a database system in performing a method 900 for sharing unstructured data, in accordance with some embodiments of the present disclosure. Method 900 may be embodied in computer-readable instructions for execution by one or more hardware components (e.g., one or more processors) such that the operations of method 900 may be performed by components of network-based database system 102, such as components of the compute service manager 108 (e.g., the data sharing manager 128) and/or the execution platform 110 (which components may be implemented as machine 1000 of FIG. 10). Accordingly, method 900 is described below, by way of example with reference thereto. However, it shall be appreciated that method 900 may be deployed on various other hardware configurations and is not intended to be limited to deployment within the network-based database system 102.

At operation 902, a share object is generated at an account of a data provider. The share object identifies an account of a data consumer and at least one unstructured data file shared with the account of the data consumer. At operation 904, the share object is configured with access privileges to the at least one unstructured data file. At operation 906, a notification of the share object is communicated to the account of the data consumer.

FIG. 10 illustrates a diagrammatic representation of a machine 1000 in the form of a computer system within which a set of instructions may be executed for causing the machine 1000 to perform any one or more of the methodologies discussed herein, according to an example embodiment. Specifically, FIG. 10 shows a diagrammatic representation of machine 1000 in the example form of a computer system, within which instructions 1016 (e.g., software, a program, an application, an applet, an app, or other executable code) for causing the machine 1000 to perform any one or more of the methodologies discussed herein may be executed. For example, instructions 1016 may cause machine 1000 to execute any one or more operations of method 900 (or any other technique discussed herein, for example in connection with FIG. 4-FIG. 9). As another example, instructions 1016 may cause machine 1000 to implement one or more portions of the functionalities discussed herein. In this way, instructions 1016 may transform a general, non-programmed machine into a particular machine 1000 (e.g., the compute service manager 108 or a node in the execution platform 110) that is specially configured to carry out any one of the described and illustrated functions in the manner described herein. In yet another embodiment, instructions 1016 may configure the compute service manager 108 and/or a node in the execution platform 110 to carry out any one of the described and illustrated functions in the manner described herein.

In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a smartphone, a mobile device, a network router, a network switch, a network bridge, or any machine capable of executing the instructions 1016, sequentially or otherwise, that specify actions to be taken by the machine 1000. Further, while only a single machine 1000 is illustrated, the term “machine” shall also be taken to include a collection of machines 1000 that individually or jointly execute the instructions 1016 to perform any one or more of the methodologies discussed herein.

Machine 1000 includes processors 1010, memory 1030, and input/output (I/O) components 1050 configured to communicate with each other such as via a bus 1002. In some example embodiments, the processors 1010 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1012 and a processor 1014 that may execute the instructions 1016. The term “processor” is intended to include multi-core processors 1010 that may comprise two or more independent processors (sometimes referred to as “cores”) that may execute instructions 1016 contemporaneously. Although FIG. 10 shows multiple processors 1010, machine 1000 may include a single processor with a single core, a single processor with multiple cores (e.g., a multi-core processor), multiple processors with a single core, multiple processors with multiple cores, or any combination thereof.

The memory 1030 may include a main memory 1032, a static memory 1034, and a storage unit 1036, all accessible to the processors 1010 such as via the bus 1002. The main memory 1032, the static memory 1034, and the storage unit 1036 store the instructions 1016 embodying any one or more of the methodologies or functions described herein. The instructions 1016 may also reside, completely or partially, within the main memory 1032, within the static memory 1034, within machine storage medium 1038 of the storage unit 1036, within at least one of the processors 1010 (e.g., within the processor's cache memory), or any suitable combination thereof, during execution thereof by the machine 1000.

The I/O components 1050 include components to receive input, provide output, produce output, transmit information, exchange information, capture measurements, and so on. The specific I/O components 1050 that are included in a particular machine 1000 will depend on the type of machine. For example, portable machines such as mobile phones will likely include a touch input device or other such input mechanisms, while a headless server machine will likely not include such a touch input device. It will be appreciated that the I/O components 1050 may include many other components that are not shown in FIG. 10. The I/O components 1050 are grouped according to functionality merely for simplifying the following discussion and the grouping is in no way limiting. In various example embodiments, the I/O components 1050 may include output components 1052 and input components 1054. The output components 1052 may include visual components (e.g., a display such as a plasma display panel (PDP), a light-emitting diode (LED) display, a liquid crystal display (LCD), a projector, or a cathode ray tube (CRT)), acoustic components (e.g., speakers), other signal generators, and so forth. The input components 1054 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures or other tactile input components), audio input components (e.g., a microphone), and the like.

Communication may be implemented using a wide variety of technologies. The I/O components 1050 may include communication components 1064 operable to couple the machine 1000 to a network 1080 or devices 1070 via a coupling 1082 and a coupling 1072, respectively. For example, the communication components 1064 may include a network interface component or another suitable device to interface with the network 1080. In further examples, communication components 1064 may include wired communication components, wireless communication components, cellular communication components, and other communication components to provide communication via other modalities. The device 1070 may be another machine or any of a wide variety of peripheral devices (e.g., a peripheral device coupled via a universal serial bus (USB)). For example, as noted above, machine 1000 may correspond to any one of the compute service manager 108 or the execution platform 110, and device 1070 may include the client device 118 or any other computing device described herein as being in communication with the network-based database system 102 or the cloud storage platform 104.

The various memories (e.g., 1030, 1032, 1034, and/or memory of the processor(s) 1010 and/or the storage unit 1036) may store one or more sets of instructions 1016 and data structures (e.g., software) embodying or utilized by any one or more of the methodologies or functions described herein. These instructions 1016, when executed by the processor(s) 1010, cause various operations to implement the disclosed embodiments.

As used herein, the terms “machine-storage medium,” “device-storage medium,” and “computer-storage medium” mean the same thing and may be used interchangeably in this disclosure. The terms refer to single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1080 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, network 1080 or a portion of the network 1080 may include a wireless or cellular network, and the coupling 1082 may be a Code Division Multiple Access (CDMA) connection, a Global System for Mobile communications (GSM) connection, or another type of cellular or wireless coupling. In this example, the coupling 1082 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 1016 may be transmitted or received over the network 1080 using a transmission medium via a network interface device (e.g., a network interface component included in the communication components 1064) and utilizing any one of several well-known transfer protocols (e.g., hypertext transfer protocol (HTTP)). Similarly, instructions 1016 may be transmitted or received using a transmission medium via coupling 1072 (e.g., a peer-to-peer coupling) to device 1070. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1016 for execution by the machine 1000, and include digital or analog communications signals or other intangible media to facilitate communication of such software. Hence, the terms “transmission medium” and “signal medium” shall be taken to include any form of a modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the disclosed methods may be performed by one or more processors. The performance of certain operations may be distributed among the one or more processors, not only residing within a single machine but also deployed across several machines. In some example embodiments, the processor or processors may be located in a single location (e.g., within a home environment, an office environment, or a server farm), while in other embodiments the processors may be distributed across several locations.

Described implementations of the subject matter can include one or more features, alone or in combination as illustrated below by way of examples.

Example 1 is a system comprising: at least one hardware processor; and at least one memory storing instructions that cause the at least one hardware processor to perform operations comprising: generating at an account of a data provider, a share object, the share object identifying an account of a data consumer and at least one unstructured data file shared with the account of the data consumer; configuring the share object with access privileges to the at least one unstructured data file; and communicating a notification of the share object to the account of the data consumer.

In Example 2, the subject matter of Example 1 includes subject matter where the at least one hardware processor further performs operations comprising: configuring a database with a schema, the database configured at an external stage associated with the account of the data provider, and the schema storing the at least one unstructured data file.

In Example 3, the subject matter of Example 2 includes subject matter where the at least one hardware processor further performs operations comprising: causing the share object to be available at the account of the data consumer before the communicating of the notification.

In Example 4, the subject matter of Examples 2-3 includes subject matter where the at least one hardware processor further performs operations comprising: generating a read-only database at the account of the data consumer based on the notification, the read-only database corresponding to the database configured at the external stage.

In Example 5, the subject matter of Example 4 includes subject matter where the at least one hardware processor further performs operations comprising: retrieving the at least one unstructured data file from the external stage associated with the account of the data provider; and storing the at least one unstructured data file in the read-only database at the account of the data consumer.

In Example 6, the subject matter of Example 5 includes subject matter where the at least one hardware processor further performs operations comprising: executing a LIST operation on the read-only database, the executing of the LIST operation causing a second notification to the account of the data consumer, the second notification including a list of unstructured data files available at the database.

In Example 7, the subject matter of Examples 5-6 includes subject matter where the at least one hardware processor further performs operations comprising: executing a GET operation on the read-only database, the GET operation identifying the at least one unstructured data file, and the executing of the GET operation causing retrieval of the at least one unstructured data file from the database.

In Example 8, the subject matter of Examples 1-7 includes subject matter where to configure the share object, the at least one hardware processor further performs operations comprising: granting READ privileges on the at least one unstructured data file to the share object.

In Example 9, the subject matter of Example 8 includes subject matter where the at least one hardware processor further performs operations comprising: configuring the access privileges in the data object to include the READ privileges on the at least one unstructured data file.

In Example 10, the subject matter of Example 9 includes subject matter where the at least one hardware processor further performs operations comprising: further configuring the data object with additional access privileges, the additional access privileges granting access to a database associated with the account of the data provider, the database storing the at least one unstructured data file.

Example 11 is a method comprising: generating, by at least one hardware processor at an account of a data provider, a share object, the share object identifying an account of a data consumer and at least one unstructured data file shared with the account of the data consumer; configuring, by at least one hardware processor, the share object with access privileges to the at least one unstructured data file; and communicating, by at least one hardware processor, a notification of the share object to the account of the data consumer.

In Example 12, the subject matter of Example 11 includes, configuring a database with a schema, the database configured at an external stage associated with the account of the data provider, and the schema storing the at least one unstructured data file.

In Example 13, the subject matter of Example 12 includes, causing the share object to be available at the account of the data consumer before the communicating of the notification.

In Example 14, the subject matter of Examples 12-13 includes, generating a read-only database at the account of the data consumer based on the notification, the read-only database corresponding to the database configured at the external stage.

In Example 15, the subject matter of Example 14 includes, retrieving the at least one unstructured data file from the external stage associated with the account of the data provider; and storing the at least one unstructured data file in the read-only database at the account of the data consumer.

In Example 16, the subject matter of Example 15 includes, executing a LIST operation on the read-only database, the executing of the LIST operation causing a second notification to the account of the data consumer, and the second notification including a list of unstructured data files available at the database.

In Example 17, the subject matter of Examples 15-16 includes, executing a GET operation on the read-only database, the GET operation identifying the at least one unstructured data file, and the executing of the GET operation causing retrieval of the at least one unstructured data file from the database.

In Example 18, the subject matter of Examples 11-17 includes subject matter where configuring the share object further comprises: granting READ privileges on the at least one unstructured data file to the share object.

In Example 19, the subject matter of Example 18 includes, configuring the access privileges in the data object to include the READ privileges on the at least one unstructured data file.

In Example 20, the subject matter of Example 19 includes, further configuring the data object with additional access privileges, the additional access privileges granting access to a database associated with the account of the data provider, the database storing the at least one unstructured data file.

Example 21 is a computer-storage medium comprising instructions that, when executed by one or more processors of a machine, configure the machine to perform operations comprising: generating at an account of a data provider, a share object, the share object identifying an account of a data consumer and at least one unstructured data file shared with the account of the data consumer; configuring the share object with access privileges to the at least one unstructured data file; and communicating a notification of the share object to the account of the data consumer.

In Example 22, the subject matter of Example 21 includes, the operations further comprising: configuring a database with a schema, the database configured at an external stage associated with the account of the data provider, and the schema storing the at least one unstructured data file.

In Example 23, the subject matter of Example 22 includes, the operations further comprising: causing the share object to be available at the account of the data consumer before the communicating of the notification.

In Example 24, the subject matter of Examples 22-23 includes, the operations further comprising: generating a read-only database at the account of the data consumer based on the notification, and the read-only database corresponding to the database configured at the external stage.

In Example 25, the subject matter of Example 24 includes, the operations further comprising: retrieving the at least one unstructured data file from the external stage associated with the account of the data provider; and storing the at least one unstructured data file in the read-only database at the account of the data consumer.

In Example 26, the subject matter of Example 25 includes, the operations further comprising: executing a LIST operation on the read-only database, the executing of the LIST operation causing a second notification to the account of the data consumer, the second notification including a list of unstructured data files available at the database.

In Example 27, the subject matter of Examples 25-26 includes, the operations further comprising: executing a GET operation on the read-only database, the GET operation identifying the at least one unstructured data file, and the executing of the GET operation causing retrieval of the at least one unstructured data file from the database.

In Example 28, the subject matter of Examples 21-27 includes subject matter where the operations for configuring the share object further comprise: granting READ privileges on the at least one unstructured data file to the share object.

In Example 29, the subject matter of Example 28 includes, the operations further comprising: configuring the access privileges in the data object to include the READ privileges on the at least one unstructured data file.

In Example 30, the subject matter of Example 29 includes, the operations further comprising: further configuring the data object with additional access privileges, the additional access privileges granting access to a database associated with the account of the data provider, the database storing the at least one unstructured data file.

Example 31 is at least one machine-readable medium including instructions that, when executed by processing circuitry, cause the processing circuitry to perform operations to implement any of Examples 1-30.

Example 32 is an apparatus comprising means to implement any of Examples 1-30.

Example 33 is a system to implement any of Examples 1-30.

Example 34 is a method to implement any of Examples 1-30.

Although the embodiments of the present disclosure have been described concerning specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is disclosed. Thus, although specific embodiments have been illustrated and described herein, it should be appreciated that any arrangement calculated to achieve the same purpose may be substituted for the specific embodiments shown. This disclosure is intended to cover any adaptations or variations of various embodiments. Combinations of the above embodiments, and other embodiments not specifically described herein, will be apparent to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

1. A system comprising:
at least one hardware processor; and
at least one memory storing instructions that cause the at least one hardware processor to perform operations comprising:
generating at a first computing node associated with an account of a data provider, a share object, the share object identifying an account of a data consumer and at least one unstructured data file shared with the account of the data consumer, the generating including creating an external stage associated with a uniform resource locator (URL), the external stage associated with the account of the data provider and storing the unstructured data file;
configuring the share object with access privileges to the at least one unstructured data file, the access privileges based on accessing the external stage using the URL; and
ending a notification of the share object for transmission to a second computing node associated with the account of the data consumer.

2. The system of claim 1, wherein the at least one hardware processor further performs operations comprising:
configuring a database with a schema, the database configured at the external stage associated with the account of the data provider, and the schema storing the at least one unstructured data file.

3. The system of claim 2, wherein the at least one hardware processor further performs operations comprising:
causing the share object to be available at the account of the data consumer before the communicating of the notification.

4. The system of claim 2, wherein the at least one hardware processor further performs operations comprising:
generating a read-only database at the account of the data consumer based on the notification, the read-only database corresponding to the database configured at the external stage.

5. The system of claim 4, wherein the at least one hardware processor further performs operations comprising:
retrieving the at least one unstructured data file from the external stage associated with the account of the data provider at least based on the URL; and
storing the at least one unstructured data file in the read-only database at the account of the data consumer.

6. The system of claim 5, wherein the at least one hardware processor further performs operations comprising:
executing a LIST operation on the read-only database, the executing of the LIST operation causing a second notification to the account of the data consumer, and the second notification including a list of unstructured data files available in the database.

7. The system of claim 5, wherein the at least one hardware processor further performs operations comprising:
executing a GET operation on the read-only database, the GET operation identifying the at least one unstructured data file, and the executing of the GET operation causing retrieval of the at least one unstructured data file from the database.

8. The system of claim 1, wherein to configure the share object, the at least one hardware processor further performs operations comprising:
granting READ privileges on the at least one unstructured data file to the share object.

9. The system of claim 8, wherein the at least one hardware processor further performs operations comprising:
configuring the access privileges in the data object to include the READ privileges on the at least one unstructured data file.

10. The system of claim 9, wherein the at least one hardware processor further performs operations comprising:
further configuring the data object with additional access privileges, the additional access privileges granting access to a database associated with the account of the data provider, the database storing the at least one unstructured data file.

11. A method comprising:
generating, by at least one hardware processor at a first computing node associated with an account of a data provider, a share object, the share object identifying an account of a data consumer and at least one unstructured data file shared with the account of the data consumer, the generating including creating an external stage associated with a uniform resource locator (URL), the external stage associated with the account of the data provider and storing the unstructured data file;
configuring, by that least one hardware processor, the share object with access privileges to the at least one unstructured data file, the access privileges based on accessing the external stage using the URL; and
encoding, by at least one hardware processor, a notification of the share object for transmission to a second computing node associated with the account of the data consumer.

12. The method of claim 11, further comprising:
configuring a database with a schema, the database configured at the external stage associated with the account of the data provider, and the schema storing the at least one unstructured data file.

13. The method of claim 12, further comprising:
causing the share object to be available at the account of the data consumer before the communicating of the notification.

14. The method of claim 12, further comprising:
generating a read-only database at the account of the data consumer based on the notification, the read-only database corresponding to the database configured at the external stage.

15. The method of claim 14, further comprising:
retrieving the at least one unstructured data file from the external stage associated with the account of the data provider at least based on the URL; and
storing the at least one unstructured data file in the read-only database at the account of the data consumer.

16. The method of claim 15, further comprising:
executing a LIST operation on the read-only database, the executing of the LIST operation causing a second notification to the account of the data consumer, and the second notification including a list of unstructured data files available in the database.

17. The method of claim 15, further comprising:
executing a GET operation on the read-only database, the GET operation identifying the at least one unstructured data file, and the executing of the GET operation causing retrieval of the at least one unstructured data file from the database.

18. The method of claim 11, wherein configuring the share object further comprises:
granting READ privileges on the at least one unstructured data file to the share object.

19. The method of claim 18, further comprising:
configuring the access privileges in the data object to include the READ privileges on the at least one unstructured data file.

20. The method of claim 19, further comprising:
further configuring the data object with additional access privileges, the additional access privileges granting access to a database associated with the account of the data provider, the database storing the at least one unstructured data file.

21. A computer-storage medium comprising instructions that, when executed by one or more processors of a machine, configure the machine to perform operations comprising:
generating at a first computing node associated with an account of a data provider, a share object, the share object identifying an account of a data consumer and at least one unstructured data file shared with the account of the data consumer, the generating including creating an external stage associated with a uniform resource locator (URL), the external stage associated with the account of the data provider and storing the unstructured data file;
configuring the share object with access privileges to the at least one unstructured data file, the access privileges based on accessing the external stage using the URL; and
encoding a notification of the share object for transmission to a second computing node associated with the account of the data consumer.

22. The computer-storage medium of claim 21, the operations further comprising:
configuring a database with a schema, the database configured at the external stage associated with the account of the data provider, and the schema storing the at least one unstructured data file.

23. The computer-storage medium of claim 22, the operations further comprising:
causing the share object to be available at the account of the data consumer before the communicating of the notification.

24. The computer-storage medium of claim 22, the operations further comprising:
generating a read-only database at the account of the data consumer based on the notification, the read-only database corresponding to the database configured at the external stage.

25. The computer-storage medium of claim 24, the operations further comprising:
retrieving the at least one unstructured data file from the external stage associated with the account of the data provider at least based on the URL; and
storing the at least one unstructured data file in the read-only database at the account of the data consumer.

26. The computer-storage medium of claim 25, the operations further comprising:
executing a LIST operation on the read-only database, the executing of the LIST operation causing a second notification to the account of the data consumer, and the second notification including a list of unstructured data files available in the database.

27. The computer-storage medium of claim 25, the operations further comprising:
executing a GET operation on the read-only database, the GET operation identifying the at least one unstructured data file, and the executing of the GET operation causing retrieval of the at least one unstructured data file from the database.

28. The computer-storage medium of claim 21, wherein the operations for configuring the share object further comprise:
granting READ privileges on the at least one unstructured data file to the share object.

29. The computer-storage medium of claim 28, the operations further comprising:
configuring the access privileges in the data object to include the READ privileges on the at least one unstructured data file.

30. The computer-storage medium of claim 29, the operations further comprising:
further configuring the data object with additional access privileges, the additional access privileges granting access to a database associated with the account of the data provider, the database storing the at least one unstructured data file.
